(19) United States
(12) Patent Application Publication
(10) Pub. No.: US 2005/0028132 A1
(43) Pub. Date: Feb. 3, 2005

(54) Application specific optimization of interpreters for embedded systems

(76) Inventors: Venugopal K. Srinivasamurthy, Bangalore (IN); Geetha Manjunath, Bangalore (IN); Venkatesh Krishnan, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/630,913

(22) Filed: Jul. 31, 2003

(51) Int. Cl. G06F 9/44

(52) U.S. Cl. 717/100

(57) ABSTRACT

The invention provides a method and apparatus for optimising the performance of interpreter-based runtime systems. The runtime system may include a virtual machine where the virtual machine is adapted to interpret an application in the context of the particular runtime environment. The method comprises augmenting the bytecode set of the virtual machine with application-specific opcodes by reference to the application, thereby constituting an application domain-specific virtual machine. The invention also provides a method and apparatus for embedding semantically enriched code opcodes into an application which is to be run on the embedded runtime environment. The embedding can be done statically or dynamically. The invention may find be used in the Java runtime environment and particular applications of such embedded processors include function-specific devices such as cell-phones, PDAs and the like.

### TECHNICAL FIELD

The present invention relates to interpreter-based runtime systems. More particularly, although not exclusively, the present invention relates to the optimisation of embedded Java Virtual Machine (JVM) interpretation, in a manner which is portable and provides substantial speed advantages compared with standard JVM interpretation. The invention also relates to methods and apparatus for adapting an embedded JVM to suit the function of a specified Java application running on the JVM. Even more particularly, although not exclusively, the invention relates to adapting a Java application to suit the applications functional relationship between a JVM on which it is running, and a target platform. The invention also contemplates a combination of an adapted JVM and Java application running on a target environment.

### BACKGROUND ART

It has become extremely common for a wide variety of electronic appliances to incorporate embedded (host) microprocessors. For example, embedded processors can be found in devices such as Personal Digital Assistants and email-enabled cellular phones. Embedded processors are often highly diverse in terms of architecture and construction and often have tightly specified capabilities and functions which are tailored to the appliance in which they are embedded. It is therefore often very costly to develop applications for a specific embedded hardware platform as this requires coding specific to the hardware architecture of the particular embedded microprocessor.

To aid in application development and also in order to be able to re-use applications running on different target environments it is highly desirable that application code be portable between different processors. This aim can be achieved by having an intermediate, high level, machine independent representation of the application along with a translational or interpretive runtime environment which executes this high level representation on the target machine. An example of such a translational application environment is the Java platform or the Java Runtime Environment (JRE). Here, the runtime environment contemplates an intermediary application which translates the high-level intermediate machine code of the compiled Java program into machine code which is comprehensible to the particular processor.

Manufacturers are deploying embedded Java runtime environments on the aforementioned types of devices to ensure portability and interoperability with software components and a key component of the runtime environment is the Java Virtual Machine.

Java virtual machines (or JVMs) play an important role in rendering Java particularly suitable for such application-specific devices. A JVM provides a layer of abstraction between a compiled Java program and the underlying hardware platform and operating system. Java programs are highly portable because they run on a JVM independent of whatever hardware architecture lies beneath the JVM implementation. A JVM can be implemented in software or in hardware in the form of an embedded processor is termed an embedded Java Virtual Machine.

Although embedded processors can be inferior in speed and code density, performance expectations remain high. This requirement forces embedded applications, including the Java runtime environment, to be squeezed for performance.

To this end, conventional wisdom holds that a Java virtual machine running in an embedded Java runtime environment constitutes a bottleneck which reduces the apparent processing speed of the application. The efficacy of the JVM therefore needs to be considered in any embedded runtime environment. Also, the rapid growth of new embedded appliances being released into the market necessitates the rapid availability of portable and efficient embedded Java environments for these platforms. This allows applications to be developed quickly and efficiently for a range of platforms and in a variety of application contexts.

One of the most distinctive characteristics of an embedded appliance is its deployment for a dedicated or mission-specific purpose. This implies that the range of applications that runs on an embedded appliance is relatively static and does not vary as much in terms of their functionality as it might on a generic computing environment. This characteristic represents a hitherto unacknowledged opportunity for optimizing the performance of an embedded Java environment for such an application.

The object of the present invention is thus to exploit the characteristically singular roles played by embedded appliance by adapting the embedded JVM to the demands of a particular Java application. It is also an object of the invention to exploit this characteristic by adapting the interaction or coupling between the JVM and target machine to the demands or functionality of the Java application itself.

### DISCLOSURE OF THE INVENTION

In one aspect the invention provides for a method of optimising the performance of an interpreter-based runtime system, said runtime system including a virtual machine, the virtual machine adapted to run an application in the context of the runtime environment, the method comprising augmenting the bytecode set of the virtual machine with application-specific opcodes by reference to said application, thereby constituting an application domain-specific virtual machine.

In a preferred aspect, the virtual machine may be a Java Virtual Machine.

Preferably the dynamic and/or static behaviour of the application is used to create new opcode for the domain-specific virtual machine.

Preferably the virtual machine is optimized based on the hierarchy of the architecture for which the runtime environment is adapted and/or the semantics of the application which is to be run on it and further wherein the virtual machine may be optimized based on a late-binding or dynamic loading model and runtime constant manifestation.

Preferably semantically enriched code is statically embedded in the application to enable it to run faster on the virtual machine which is newly generated in accordance with the aforementioned method.

Alternatively, semantically enriched code is dynamically embedded in the application to enable it to run faster on the virtual machine, said virtual machine newly generated in accordance with the aforementioned method.

The semantically enriched code may determined by performing a quantitative trade-off between time and space and is preferably determined based on the dynamic and/or static behaviour of the application.

In a further aspect, the invention provides for a method of generating an embedded virtual machine for a specific domain of applications based on embedding semantically enriched code in the interpreter loop of the virtual machine.

Preferably the semantically enriched code embedding step is performed dynamically on newly loaded portions of the application in dynamic languages.

Preferably the interpreter is dynamically enhanced.

Secondary codes may be used to accommodate the interpretation of new semantically enriched codes.

In such a case, the encoding of the new semantically enriched codes of the instruction set of the virtual machine may be performed for efficient decoding of the most frequently executed codes.

Thus, if, a particular code is used very frequently, it may be made into a single byte code and the rest of the semantically enriched codes are accommodated by secondary codes.

In yet a further aspect, the invention provides for a method of optimising the performance of applications running on an interpreter-based runtime system, the method comprising augmenting the bytecode set of the interpreter with application-specific opcodes by reference to said application, thereby constituting an application domain-specific virtual machine.

In yet a further aspect, the invention provides for a method of symbolically executing semantically enriched code op code or virtual machine instructions for the purpose of integrated code generation and optimization, wherein said method of execution is adapted so as to be based on the semantics of an application which is to be run on the runtime environment thereby increasing the efficacy of the interaction between the application and the environment in which it is to be executed.

In a further aspect, the invention provides for a computer system adapted to perform any of the methods as hereinbefore defined.

A yet a further aspect, the invention provides for a computer program adapted to perform any of the methods as hereinbefore defined.

### BRIEF DESCRIPTION OF THE DRAWINGS

The present invention will now be described by way of example only and with reference to the drawings in which:

FIG. 1: illustrates the an abstract layer representation of the relationship between the Java application, the JVM and the target environment;

FIG. 2: illustrates the three primary phases of one embodiment of the invention;

FIG. 3: illustrates two examples of basic block bytecode sequences corresponding to two new application specific opcodes deduced from an application used for performance comparison

FIG. 4a: illustrates sample disassembly of two Java classes;

FIG. 4b: illustrates Java byte code sequences for classes shown in FIG. 4a highlighting possible candidates for sEc opcode;

FIG. 5: illustrates Java bytecode sequences for classes shown in FIG. 4a based on dynamic optimisation; and

FIG. 6: illustrates sEc symbolic execution on the sEc opcode according to one embodiment of the invention.

### BEST MODE FOR CARRYING OUT THE INVENTION

The present invention will now be described with reference to Java applications running on embedded Java Virtual Machines. However, it is to be understood that the present invention may find application in other virtual machine environments where portable code is semantically enriched as a function of the particular application which is to be run on the device. Thus the following detailed exemplary embodiment is not intended to be limiting and is provided to illustrate and explain the salient features of an example of the present technique.

By way of preliminary definition, Java programs are compiled by a Java compiler into a form called Java bytecode. Java bytecode is executed by the JVM and can be likened to machine language or Java object code. From the point of view of the JVM, a stream of bytecode represents a sequence of instructions. Each instruction consists of a one-byte opcode and zero or more operands. The opcodes tell the JVM what action to take and supplemental information which may be required to execute the opcodes is carried in the operands.

The technique described herein of aggressively optimizing an embedded Java virtual machine interpreter in a portable way is referred to by the applicants as Semantically Enriched Code, or “sEc”. The sEc technique is motivated by the characteristics exhibited by the three building blocks of the Java application environment: namely the Java application, the Java virtual machine; and the target environment along with the two couplings that exist between them.

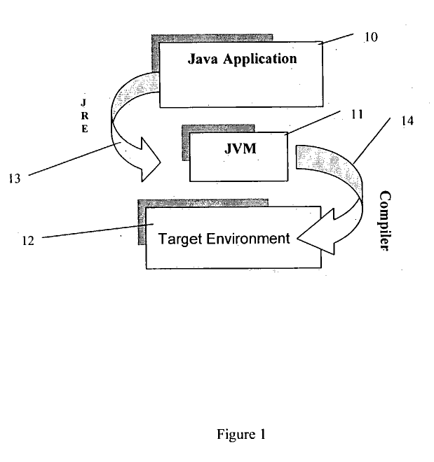

This relationship is illustrated in FIG. 1 where a layer abstraction diagram is shown. Referring to FIG. 1, the Java application layer 10, the JVM 11 and the target environment 12 are shown. The Java runtime environment is represented by the coupling 13 between the Java application and the JVM 11. The coupling between the JVM 11 and the target environment is represented by the compilation coupling 14.

A Java application 10 can be characterized by its object oriented nature which results in the application being method-call intensive. This means that the programs are generally dominated by small methods with frequent method invocations. Java applications are also characterised by having a garbage collection approach which frees a Java program from memory related problems such as pointer chasing and dangling pointers. Lastly, the dynamic nature of Java applications allows them to be characterised by the 80-20 rule. That is, 80% of the execution time is spent on 20% of the actual application.

The important characteristics of the embedded JVM 11 are as follows. Normally, a JVM is divided into the registers, the stack, the garbage-collected heap, and the method area. A JVM is therefore a stack-based virtual machine where the stack is emulated using the heap and JVM operations are thus dominated by stack operations.

During execution of a Java program, the JVM is run on a real (target) machine and the bytecode corresponding to the compiled Java source for the application is interpreted by the JVM. The bytecode spends approximately 80% of its execution time in the interpreter loop. It is noted that the interpreted JVM bytecodes have a high semantic content when compared to the target machine instructions. The JVM further provides the semantics of dynamic loading of classes as a language feature. In terms of execution, this is manifested as the late binding model for runtime entities.

By way of example, the embedded target environment 12 of FIG. 1 may be register based RISC or CISC machine. These target architectures are generally created for a dedicated purpose which implies that applications running on the embedded environment are relatively static. Thus, as alluded to above, applications running on the target environments must be portable and efficient.

At the time of execution of the compiled Java application, the above-mentioned characteristics of the Java application and the JVM give rise to two couplings: the Java runtime environment (JRE); and the compilation coupling between the JVM and the target environment.

The JRE coupling 13 arises between the compiled Java application 10 and the JVM 11 at interpretation time and it is hence dynamic in nature. It is a general characteristic of object-oriented runtime environments to resort to pointer indirection in order to support polymorphism and runtime type-checking. Other JVM sub-modules referred to above, namely garbage collection and object management also have the effect of making this coupling pointer-intensive. On the other hand, the high semantic content of interpreted JVM bytecode causes the implementation of the corresponding JVM interpreter actions to introduce, on average, one or more function calls per opcode. This makes the JRE coupling 13 call-intensive.

The compilation coupling 14 occurs between the JVM and the target environment and arises during compilation of the JVM source and is therefore static. Simply compiling the JVM source introduces a number of disadvantages. Firstly, the JVM characteristics mentioned above introduce imprecise information into the compilation process and thus may hamper compiler optimisation. Also, the pointer-intensive characteristics of the JVM source introduce data dependencies leading to a lack of precision in optimisation transformations on the JVM code. Secondly, the pointer-intensive and call-intensive nature of the JVM introduces control dependencies which may hamper inter-procedural analysis. Present target hardware is more efficient when jumping to a constant address than when indirectly fetching an address from a table due to instruction stalls in the latter case. Thirdly, the compiler used to (cross) compile JVM source is unaware of both high-level JVM semantic constructs and architecture, and therefore fails to exploits any precise information such as the semantics of the stack operations. Finally, the late binding model of the JVM hampers optimisations by deferring binding specification until runtime. Therefore, precise information about the binding address of symbols and the branch targets will increase the efficacy of any optimisation of the JVM interpreter action code.

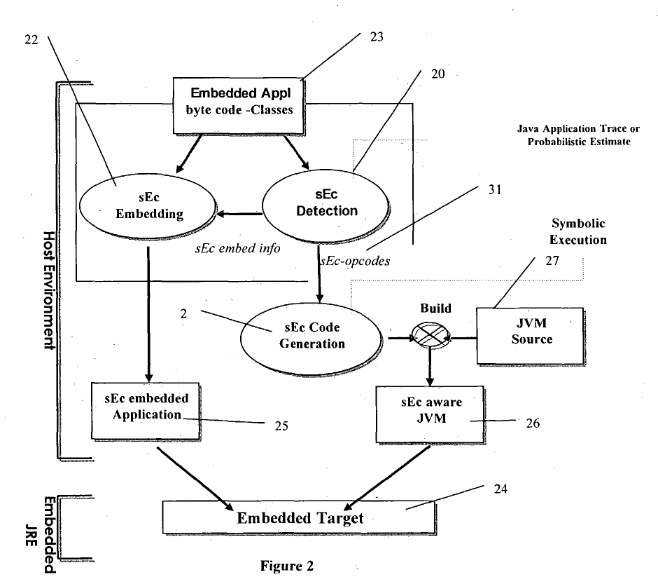

Thus, a first aim of the invention is to make the application drive the semantic content of the JVM 11 by creating new opcodes (sEc opcodes). This results in an adaptive code set for a particular JVM 11 thus creating an application-specific or application-tuned JVM (26 in FIG. 2). This results in the semantic content of the JVM 11 being driven bottom-up from the application's static or dynamic behaviour as opposed to top-down/fixed pattern repository as found in many intermediate languages. A second aim is to perform aggressive, offline optimisation for speed of frequently executed instruction traces, while exploiting information on runtime constants. In effect this results in subsequent implementations of the stack-based JVM being tightly coupled to the real target (register-based) machines. This is contrary to Just-in-time (JIT) compilation or Dynamic Code Generation where optimisation is done at execution time.

The present embodiment of the semantically enriched code (sEc) technique can be broken down into three broad phases and are shown in FIG. 2: (1) sEc detection 20; (2) sEc optimization and code generation 21; and (3) sEc embedding 22. These phases will be discussed in turn.

(1) sEc Detection

This phase deduces the effective sEc-opcodes 31. As noted above, sEc-opcode is a flow sensitive maximal computational sequence of Java bytecode deduced, for speed, from the Java application's static or dynamic behaviour. Here, ‘flow sensitive’ means sensitive to the control and data flow of an application. The effective sEc-opcodes 31 (i.e. new bytecode in the JVM) are deduced from the particular behaviour of the given embedded Java application that will speedup the runtime of a given Java application 27. That is, new bytecode is deduced from the stream of compiled Java bytecode present in the application 23

The sEc detection phase can be further subdivided into static or dynamic sEc detection stages (not shown in FIG. 2), both of which have the aim of deducing effective sEc-opcodes from a stream of Java bytecode which will produce an overall speedup in the execution of the Embedded Java runtime environment.

In the static sEc detection phase, the particular compiled Java application is parsed for the most repetitive longest sequence of Java bytecodes. sEc bytecodes are selected from these based on cost and control flow criteria. This approach does not capture the dynamic semantics of the application as the bytecode patterns may not account for the dominant dynamic behaviour of the Java application. Thus, this detection technique is better suited for space optimisation of Java applications on an embedded platform. In effect, this technique captures spatial localisation of the Java bytecode rather than temporal localisation.

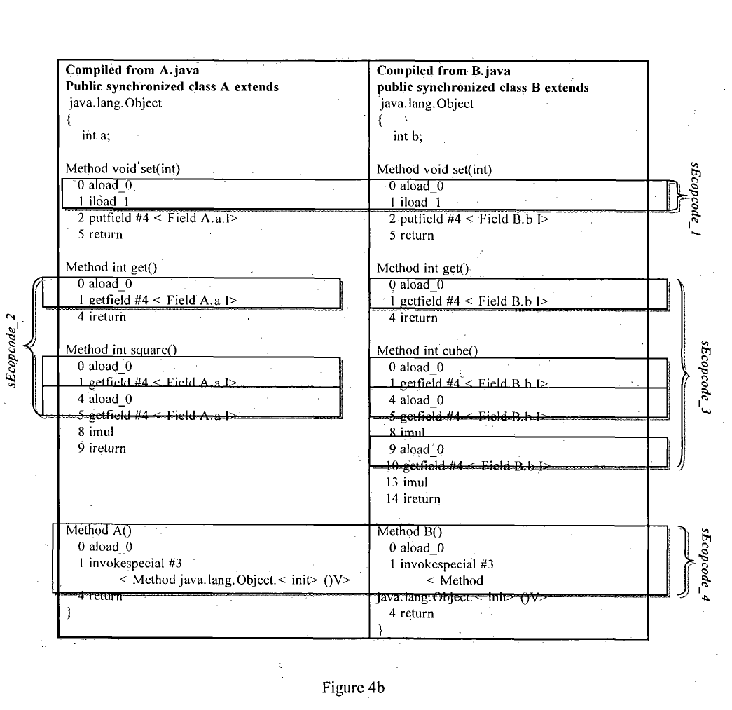

FIGS. 4a and 4b illustrates this concept. If two Java classes, A and B are considered, FIG. 4a shows the corresponding Java disassembly of A and B classes. Static sEc detection parses all of the methods present in both classes A and. B. Referring to FIG. 4b, four sEc-opcodes: sEc-opcode_{—}1, sEc-opcode_{—}2, sEc-opcode_{—}3 and sEc-opcode_{—}4 are selected from the static Java bytecode stream. Identical patterns of Java bytecode sequences for each sEc-opcode are represented in FIG. 4b by the horizontal windows. Some of the opcodes, sEc-opcode_{—}1 and sEc-opcode_{—}4 are sequences across given classes and some (the remainder) are within a class, although not necessarily restricted to the same class. This technique leads to bytecode compression by replacing every occurrence of most repetitive longest sequences by a respective macro name.

In contrast, dynamic sEc detection exploits the dynamic behaviour of the Java application when deducing the sEc-opcodes. This method uses the profile of a particular Java application, which is generated using representative input as the best approximation of the dynamic semantics of the application. Determining the optimal sequence of bytecode to select as the sEc opcodes with respect to speed as well as space criteria is a combinatorially difficult problem. Hence, heuristics based on greedy and non-greedy approaches are used.

The first of these is based on a greedy selection of the bytecode sequence which captures the longest repetitive computational sequence of the dynamic bytecode stream. The main disadvantage of this method is that it is insensitive to control flowing into this sequence. Also, ensuring correct sequences with multiple branch targets in sEc opcodes 31 along with Java's precise exceptions produces overhead which can cut into any anticipated gain in performance.

The non-greedy bytecode sequence selection approach will deduce the sEc-opcode bytecode sequence under structural constraints such as control and data flow. The structural constraints can result in a simple basic block, an extended basic block or a fragment. These constraints improve the efficacy of sEc-opcode optimisation compared to multiple branch targets in the sec-opcode.

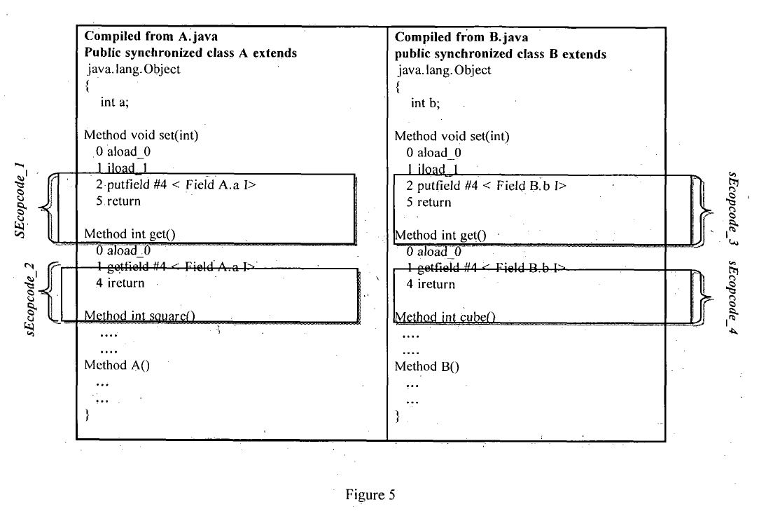

Referring to FIG. 5, assuming that objects of class A and B are created sparingly at runtime and except for the method ‘set’ and ‘get’, all other methods, square, cube and init, are sparingly used in the profile. Under these conditions dynamic sEc detection will deduce sEc-opcodes sEc-opcode_{—}1, sEc-opcode_{—}2, sEc-opcode_{—}3, and sEc-opcode_{—}4 as shown in FIG. 5. This method does not look at unused classes, methods and parts of methods, i.e. those which are not traced in the profile. Therefore the pattern space is limited to the runtime behaviour of the application. Thus dynamic sEc-opcode detection gives rise to sEc-opcodes which are semantic constructs as runtime cost criteria as opposed to static sEc detection which is a static construct.

(2) sEc Optimization and Code Generation.

Here, sEc-opcodes 31 are taken as input and efficient native code is generated 21. In the present example, this process maps the bytecode sequence in the sEc-opcode onto optimized portable native C code for the target machine 24. This code corresponds to the JVM interpreter action code for the sEc-opcode. This sequence is illustrated in FIG. 2 with reference to functional blocks 21, 27 and 26. Action code for a virtual machine opcode can be defined as a piece of code in a high level language, such as C, that emulates the semantics of that opcode as per the specification of the instruction set of that Virtual Machine.

The aim of the sEc code generator is to generate efficient and portable C code for the sEc-opcodes. A naïve sEc code generator would simply concatenate the corresponding JVM interpreter action code for all of the individual bytecodes in the given sEc-opcode. However, several optimisations are also performed during this phase.

The sEc code generation must abide by structural constraints that the Java bytecode specifies, namely stack invariance of Java bytecode and variant data typing of the Java stack frame. Stack invariance of Java bytecode is where each bytecode must only be executed with the appropriate type and number of arguments on the operand stack or in local variables, regardless of the execution path that leads to its invocation. Variant data typing of the Java stack frame is where at different points in the same method, the local variable slot in a Java invocation frame can hold different data types.

The sEc code generation method generates the code for every sEc-opcode in an application keeping track of the JVM internal state by symbolic interpretation. Symbolic execution can be treated as having execution semantics as opposed to static semantics in abstract interpretation. Tracking changes in the JVM state symbolically facilitates the code generation to perform JVM dependent optimisation.

This optimization process is effective not only because the bytecode dispatch overhead is eliminated for the bytecode in the sEc-opcode, but also because stack operands are folded, redundant local variable access is eliminated and more precise semantic information related to the JVM domain is available for the offline C compiler optimisation. The resultant C code is then subjected to further optimisation with respect to the target architecture semantics. This can be done using a global optimizing compiler such as gcc. This yields an optimised action code for the sEc opcode which results in a tighter coupling between the JVM and the target machine semantics in the resulting sEc-aware JVM 26.

As the stack based JVM opcodes are emulated over the register-based target machine instructions, the sEc technique allows various forms of sEc-opcode optimisation. These include virtual machine architecture dependant optimisations; virtual machine architecture independent optimisations; virtual machine runtime bindings; and target architecture dependent and independent optimisations.

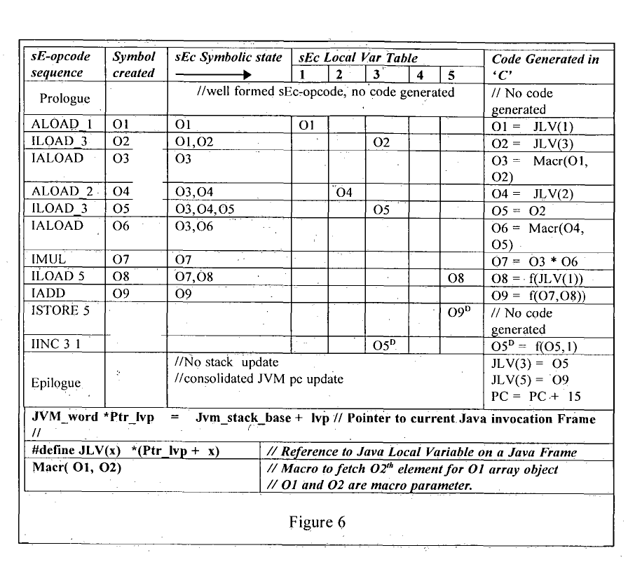

A technique referred to as sEc symbolic execution is employed during the code generation phase (FIG. 2) wherein an integrated optimizer and code generator optimizes the sEc-opcode with respect to the JVM semantic domain as well as the target architecture semantic domain and generates the JVM action code in C. The different intermediate states of this process and the output code generated for a sample sEc opcode is illustrated in FIG. 6.

(3) sEc Code Embedding

This last phase embeds (22) the sEc-opcode 31 into the Java application and also modifies the JVM 27 to support the new sEc-opcode interpreter action. The sEc embedding 22 can be performed online or offline.

The JVM 27 is modified as follows. The JVM interpreter loop is modified to detect and execute the new sEc opcode 31. When performed offline, modifications relating to the JVM source 27, primarily the interpreter, are done in the host environment of the embedded target and cross built to obtain the sEc-aware JVM 26. According to the online model, a generic JVM is modified to have a stub. The function of this stub is to automatically load the new sEc-opcode 31 when the main interpreter loop traps the new sEc-opcode. The disadvantage of the latter method is the necessity to dynamically load modules in the runtime environment.

The sEc-opcode 31 is embedded into the Java application 25 by modifying the CODE attribute of the Java method (see section 4.7.3 of the JVM specification). This process can be performed either offline or online. In the offline mode of embedding of sEc opcode in a Java application, a single pass over the application bytecode is performed to substitute the required sequence of bytecodes with the corresponding sEc opcode. The applicable class methods can be rewritten with the new sEc-opcode using bytecode rewriting tools thereby producing the sEc embedded application 25.

In the online model, the Java bytecode sequence of the new sEc-opcode is replaced at the runtime of the application using a special class loader. The sEc detection phase gives the sEc-hook information which incorporates information relating to the location of the new sEc-opcode (class, method and offset) and the size of the replaced bytecode sequence. This information can be used to speed up the embedding phase. The class loader will track the first call to the methods which are to be sEc-opcode embedded using sEc-hook information and the method code attributes of the method are then rewritten with the corresponding sEc-opcode. Thereafter, execution resumes the normal interpretation path. The sEc-hook helps the special class loader to pinpoint the method, location and size of the bytecode stream to be rewritten in the corresponding sEc-opcode.

The applicants have carried out trials of the invention using an in-house JVM to analyse and instrument the sEc technique. The host environment was HP-UX 10.20 and the embedded environment was an NS486 based custom embedded environment. A GCC compiler was used for cross-compilation. Dynamic sEc detection was performed with non-greedy heuristics and the basic-block structural constraint. That is, bytecode patterns were limited to basic blocks. Further selection of bytecode sequence for the sEc opcodes was based on the BHC (bytecode hit count) which corresponds to the product of the execution frequency of the basic-block and the number of opcodes in the basic-block.

The JVM was instrumented to obtain the BHC and sEc-hook information for every basic block.

The Benchmarks ECM (embedded caffeine mark) and Jlex (Java lexical analyser) were used to study the effect of the sec-opcode on the dynamic semantics of applications and their impact on the speed and space of the applications. The cumulative NHC data of the ECM shows that 6% of basic-blocks account for 99.7% of the total BHC for the ECM. This amounts to 34 basic blocks and the probably sEc-opcodes for the ECM application. Similarly, 2.5% of basic-blocks cover 98% of the BHC in Jlex. This amounts to 40 basic blocks and these are the most probably candidates for sEc-opcodes.

A similar treatment of JVM code sizes for every addition of a sEc-opcode can be performed. This provides the ability to perform a fine-grained quantitative trade-off between application speed and target space constraints. It is noted that the number of extended basic blocks and the fragments that account for the most execution time will be less than the number of basic blocks using the basic block structural criteria.

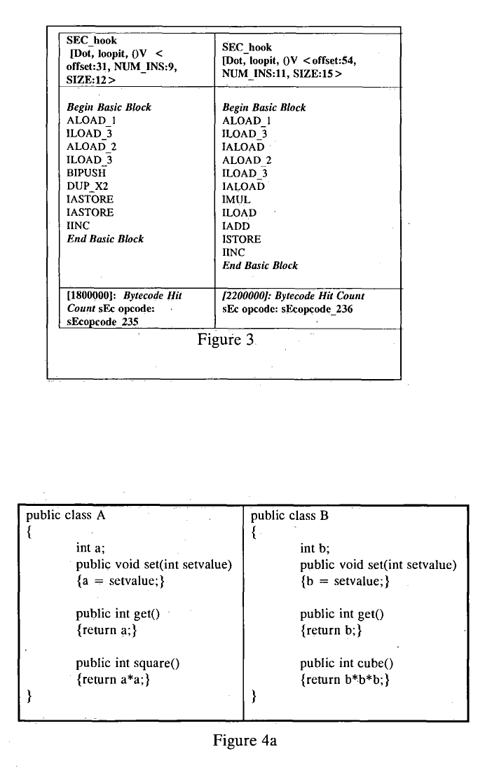

The dot-product benchmark was used to study the speedup of the JVM. The application was subjected to sEc-detection as described above. Consideration was restricted to the two basic block bytecode sequences as shown in FIG. 3 and the sEc-opcodes which were then deduced: namely sEc-opcide_{—}235 and sEc-opcode_{—}236. These sequences had the highest BHC. The sEc-opcode_{—}235 and sEc-opcode_{—}236 were subjected to the sEc code generation algorithm, that is, sEc symbolic execution, performed manually with the JVM dependant optimisations. The resulting C code was used to augment the generic JVM.

The JVM was modified offline to be aware of the new sEc-opcodes. The action (C) code was embedded into the JVM interpreter loop and JVM specific changes were made to recognise the new sEc-opcodes. The JVM was then built using the gcc compiler with the highest level of optimisation enabled.

Online sEc-opcode embedding was adopted to replace the sequence of bytecode comprising the sEc-opcode with a single corresponding sEc-opcode. A new class loader was introduced into the JVM to read the sEc-hook information and track all of the loaded classes for embedding the sEc-opcodes at the sEc-hook specified locations. This modification resulted in a speedup of approximately 300%. It is noted that only two sEc-opcodes were considered for experimentation purposes. Also the bytecode sequences in the sEc-opcodes are less rich in semantics compared to semantically rich opcodes like those for object management and method invocation. This would provide further scope for optimisation.

The present invention therefore provides an innovative technique which avoids the problems of efficiently integrating traditional compilation phases into the Java runtime environment, by semantically enriching Java bytecode using the sEc technique. This is a problem for JIT (just in time) techniques which the invention goes some way to addressing.

Thus, trials have shown that even modifications with limited scope may provide substantial improvements in the performance of JVM interpretation for some Java applications. The sEc technique employs C as its intermediate language and therefore is portable to many embedded platforms. This reduces porting and retargeting cost and time. The invention also provides a mechanism for providing ability to making a fine-grained trade-off between speed and space in an embedded JVM.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A method of optimising the performance of an interpreter-based runtime system, said runtime system including a virtual machine, the virtual machine adapted to run an application in the context of the runtime environment, the method comprising augmenting the bytecode set of the virtual machine with application-specific opcodes by reference to said application, thereby constituting an application domain-specific virtual machine.

2. A method as claimed in claim 1 wherein the virtual machine is a Java Virtual Machine.

3. A method as claimed in claim 1 wherein a new domain-specific virtual machine is generated for different categories of applications.

4. A method as claimed in claim 1 wherein the dynamic and/or static behaviour of the application is used to create new opcode for the domain-specific virtual machine.

5. A method as claimed in claim 1 wherein the virtual machine is optimized based on the hierarchy of the architecture for which the runtime environment is adapted and/or the semantics of the application which is to be run on it.

6. A method as claimed in claim 1 wherein the virtual machine is optimized based on a late-binding or dynamic loading model and runtime constant manifestation.

7. A method as claimed in claim 1 wherein semantically enriched code is statically embedded in the application to enable it to run faster on the virtual machine which is newly generated in accordance with claim 1.

8. A method as claimed in claim 1 wherein semantically enriched code is dynamically embedded in the application to enable it to run faster on the virtual machine, said virtual machine newly generated in accordance with claim 1.

9. A method as claimed in claim 7 wherein the semantically enriched code is determined by performing a quantitative trade-off between time and space.

10. A method as claimed in claim 7 wherein the semantically enriched code is determined based on the dynamic and/or static behaviour of the application.

11. A method of generating an embedded virtual machine for a specific domain of applications based on embedding semantically enriched code in the, interpreter loop of the virtual machine.

12. A method as claimed in claim 12 wherein the semantically enriched code embedding step is performed dynamically on newly loaded portions of the application in dynamic languages.

13. A method as claimed in claim 12 wherein the interpreter is dynamically enhanced.

14. A method as claimed in claim 1 wherein secondary codes are used to accommodate the interpretation of new semantically enriched codes.

15. A method as claimed in claim 14 wherein the encoding of the new semantically enriched codes of the instruction set of the virtual machine is performed for efficient decoding of the most frequently executed codes.

16. A method as claimed in claim claim 14 wherein if, a particular code is used very frequently, it is made into a single byte code and the rest of the semantically enriched codes are accommodated by secondary codes.

17. A method of optimising the performance of applications running on an interpreter-based runtime system, the method comprising augmenting the bytecode set of the interpreter with application-specific opcodes by reference to said application, thereby constituting an application domain-specific virtual machine.

18. A method of symbolically executing semantically enriched code opcode or virtual machine instructions for the purpose of integrated code generation and optimization, wherein said method of execution is adapted so as to be based on the semantics of an application which is to be run on the runtime environment thereby increasing the efficacy of the interaction between the application and the environment in which it is to be executed.

19. A computer systems adapted to perform the method as claimed in claim 1.

20. A computer program adapted to perform the method as claimed in claim 1.
